(19) United States
(12) Patent Application Publication
(10) Pub. No.: US 2026/0104809 A1
(43) Pub. Date: Apr. 16, 2026

(54) MEMORY SYSTEM, OPERATION METHOD AND SYSTEM

(71) Applicant: YANGTZE MEMORY TECHNOLOGIES CO., LTD., Wuhan (CN)

(72) Inventors: Mo CHENG, Wuhan (CN); Tianyi WANG, Wuhan (CN)

(21) Appl. No.: 19/022,827

(22) Filed: Jan. 15, 2025

(30) Foreign Application Priority Data
Oct. 12, 2024 (CN) 2024114260667

(51) Int. Cl. G06F 3/06

(52) U.S. Cl. CPC G06F 3/0623; G06F 3/0659; G06F 3/0679

(57) ABSTRACT

The disclosure provides a memory system and an operation method and a system, wherein the memory system comprises: a memory device; and a controller coupled to the memory device and configured to: receive a command comprising address information and a flag bit of target data, wherein the flag bit is to indicate whether to delete the target data; perform a delete operation on the target data based on the flag bit being in a state indicating to delete the target data.

### CROSS-REFERENCE TO RELATED APPLICATION

The present application claims priority to Chinese Patent Application No. 2024114260667, which was filed October 12, 2024, and is hereby incorporated herein by reference in its entirety.

### TECHNICAL FIELD

The present disclosure relates to the field of semiconductor technology, and in particular, to a memory system and an operation method and a system.

### BACKGROUND

With the rapid development of data storage technologies, more and more data memory systems appear in electronic devices used by people, such as Secure Digital Memory Card (SD card), Universal Flash Storage (UFS), Solid State Drives (SSD), and the like.

### SUMMARY

The example of the disclosure provides a memory system and an operation method and a system.

In order to achieve the above object, the technical solutions of the examples of the present disclosure are implemented as follows:

According to a first aspect, an example of the present disclosure provides a memory system, comprising: a memory device; and a controller coupled to the memory device and configured to:

receive a command comprising address information and a flag bit of target data, wherein the flag bit is to indicate whether to delete the target data;

perform a delete operation on the target data based on the flag bit being in a state indicating to delete the target data.

In an example, the target data is stored in the memory device.

In an example, the controller is further configured to:

unmap mapping information of logical address to physical address of the target data in response to the command.

In an example, the memory device comprises a plurality of memory blocks, and prior to performing the delete operation, the controller is further configured to:

transfer valid data in the same memory block as the target data to another memory block.

In an example, after the delete operation is completed, the controller is further configured to:

generate completion response information for the command.

In an example, the command comprises an unmap command or a dataset management command.

In a second aspect, an example of the present disclosure provides a system, comprising: a memory system; and a host coupled to the memory system, wherein the memory system comprises a memory device and a controller coupled to the memory device, wherein

the host is configured to: send a command comprising address information and a flag bit of target data, wherein the flag bit is to indicate whether to delete the target data; and

the controller is configured to: receive the command; and perform a delete operation on the target data based on the flag bit being in a state indicating to delete the target data.

In an example, the host comprises: a memory; and a processor coupled to the memory and configured to:

receive a request; and

set the flag bit to the state indicating to delete the target data based on the request comprising a requirement of deleting the target data.

In an example, the target data is stored in the memory device.

In an example, the controller is further configured to:

unmap mapping information of logical address to physical address of the target data in response to the command.

In an example, the memory device comprises a plurality of memory blocks, and prior to performing the delete operation, the controller is further configured to:

transfer valid data in the same memory block as the target data to another memory block.

In an example, after the delete operation is completed, the controller is further configured to:

generate completion response information for the command; and send the completion response information to the host.

In an example, the command comprises an unmap command or a dataset management command.

According to a third aspect, an example of the present disclosure provides an operation method of a memory system, comprising:

receiving a command comprising address information and a flag bit of target data, wherein the flag bit is to indicate whether to delete the target data; and

performing a delete operation on the target data based on the flag bit being in a state indicating to delete the target data.

In an example, the target data is stored in a memory device.

In an example, the operation method further includes:

unmapping mapping information of logical address to physical address of the target data in response to the command.

In an example, prior to performing the delete operation, the operation method further comprises:

transferring valid data in the same memory block as the target data to another memory block.

In an example, after the deleting operation is completed, the operation method further comprises:

generating completion response information for the command.

### BRIEF DESCRIPTION OF THE DRAWINGS

FIG. 1 is a schematic diagram of a system according to an example of the present disclosure.

FIG. 2 is a schematic diagram of a memory card according to an example of the present disclosure.

FIG. 3 is a schematic diagram of a solid state disk according to an example of the present disclosure.

FIG. 4 is a schematic composition diagram 1 of a memory device according to an example of the present disclosure.

FIG. 5 is a schematic composition diagram 2 of a memory device according to an example of the present disclosure.

FIG. 6 is a schematic composition diagram 1 of a system according to an example of the present disclosure.

FIG. 7 is a schematic flowchart 1 of a framework according to an example of the present disclosure.

FIG. 8 is a schematic composition diagram 2 of a system according to an example of the present disclosure.

FIG. 9 is a schematic diagram of a format of an unmap command according to an example of the present disclosure.

FIG. 10 is a schematic diagram of a format of a dataset management command according to an example of the present disclosure.

FIG. 11 is a schematic diagram of a data transfer operation according to an example of the present disclosure.

FIG. 12 is a schematic flowchart 2 of a framework according to an example of the present disclosure.

FIG. 13 is a schematic flowchart of an operation method of a memory system according to an example of the present disclosure.

### DETAILED DESCRIPTION

Examples disclosed in the present disclosure will be described in more detail below with reference to the accompanying drawings. While examples of the present disclosure are shown in the drawings, it should be understood that the disclosure may be implemented in various forms and should not be limited by the DETAILED DESCRIPTION set forth herein. Rather, these examples are provided to enable a more thorough understanding of the present disclosure and to fully convey the scope of the disclosure to those skilled in the art.

In the following description, numerous specific details are given in order to provide a more thorough understanding of the present disclosure. It will be apparent to those skilled in the art, however, that the present disclosure may be practiced without one or more of these details. In other examples, to avoid confusion with the present disclosure, some technical features well-known in the art are not described; for example, all features of the actual examples are not described herein, and well-known functions and structures are not described in detail.

In the drawings, like reference numerals refer to like elements throughout.

It should be understood that spatial relation terms such as “under”, “below”, “beneath”, “underneath”, “over”, “above”, etc., may be used herein for ease of description to describe the relationship between one element or feature and other elements or features shown in the figures. It should be appreciated that in addition to the orientations shown in the figures, the spatial relation terms also intend to include different orientations of the devices in use and operation. For example, if the devices in the figures are turned over, then the elements or features described as “below” or “underneath” or “under” the other elements will be oriented “on” the other elements or features. Thus, the example terms “below” and “under” may include both above and below orientations. The devices may be additionally oriented (rotated 90 degrees or at other orientations) and the spatial description terminology used herein is interpreted accordingly.

The terminology used herein is for the purpose of describing particular examples only and is not to be taken as a limitation of the present disclosure. As used herein, “a,” “an,” and “the” in singular forms are intended to include plural forms as well, unless the context clearly indicates otherwise. It should also be understood that at least one of the terms "consists of" or "comprising", when used in this specification, identify the presence of at least one of stated features, integers, operations, elements or components, but do not preclude the presence or addition of at least one of one or more other features, integers, operations, elements, components or groups. As used herein, the term “at least one of …” includes any and all combinations of related listed items.

The memory system in the examples of the present disclosure includes, but is not limited to, a memory system including a three-dimensional NAND type memory, and for ease of understanding, the memory system provided by the present disclosure is described by taking a memory system including a three-dimensional NAND type memory as an example.

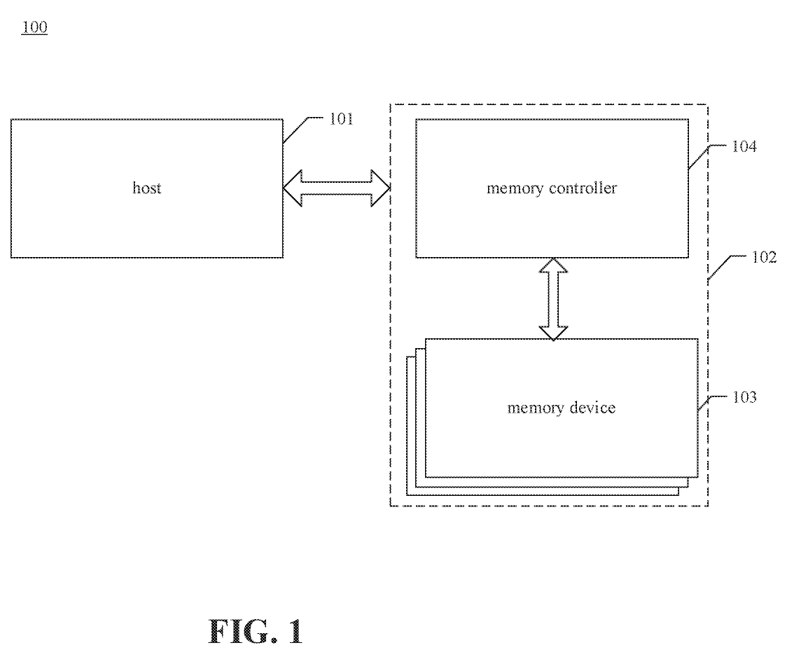

FIG. 1 is a schematic diagram of an example system with a memory system according to an example of the present disclosure. In an example of the present disclosure, the system 100 may comprise a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the system 100 may include a host 101 and a memory system 102, which may include one or more memory devices 103 and a memory controller 104.The host 101 may include a processor of an electronic device, for example, a central processing unit (CPU), or a system on a chip (SoC), for example, an application processor (AP).The host 101 may be configured to send or receive data to or from the memory system 102.

In some examples, the memory controller 104 is coupled to the memory device 103 and the host 101 and is configured to control the memory device 103. The memory controller 104 may manage data stored in the memory device 103 and communicate with the host 101.In some examples, the memory controller 104 is designed to operate in a low duty cycle environment, such as in a secure digital card, compact flash card (CFC), universal serial bus (USB) flash drive, or other medium for use in electronic devices such as personal computers, digital cameras, mobile phones, and the like. In other examples, the memory controller 104 is designed to operate in a high duty cycle environment, such as a solid state disk or embedded Multi-Media Card (eMMC).

In some examples, the memory controller 104 and the one or more memory devices 103 may be integrated into various types of storage devices, for example, the memory system 102 may be implemented and packaged into different types of end electronic products.

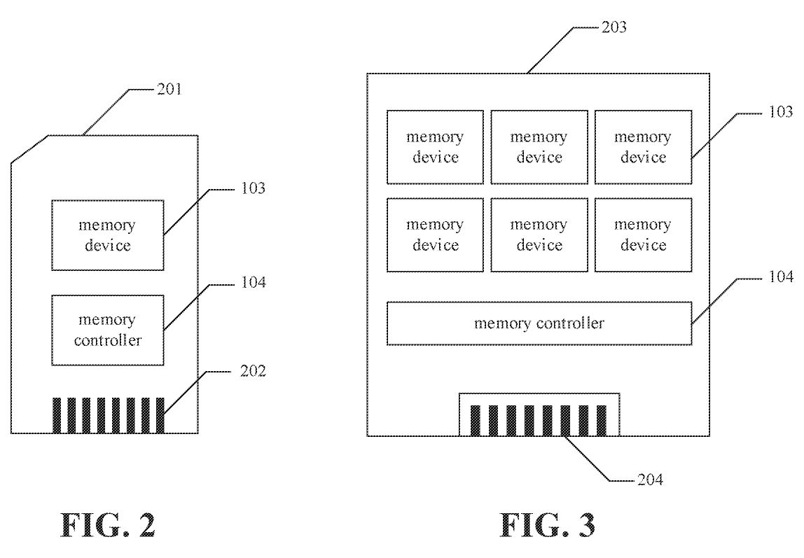

In one example as shown in FIG. 2, the memory controller 104 and a single memory device 103 may be integrated into a memory card 201.The memory card 201 may comprise one of a compact flash memory card, a smart media card (SMC), a memory stick (MS), a multimedia card (MMC), for example, an RS-MMC, an MMCmicro, an eMMC, or the like, a secure digital card, for example, a Mini SD card, a Micro SD card, an SDHC card, or the like, and a universal flash memory card. The memory card 201 may also include a memory card connector 202 that couples the memory card 201 with a host (e.g., host 101 in FIG. 1). In another example as shown in FIG. 3, the memory controller 104 and a plurality of memory devices 103 may be integrated into an SSD 203. The SSD 203 may also include an SSD connector 204 that couples the SSD 203 with a host (e.g., host 101 in FIG. 1).In some examples, at least one of the storage capacity or operating speed of the SSD 203 is greater than that of the memory card 201.

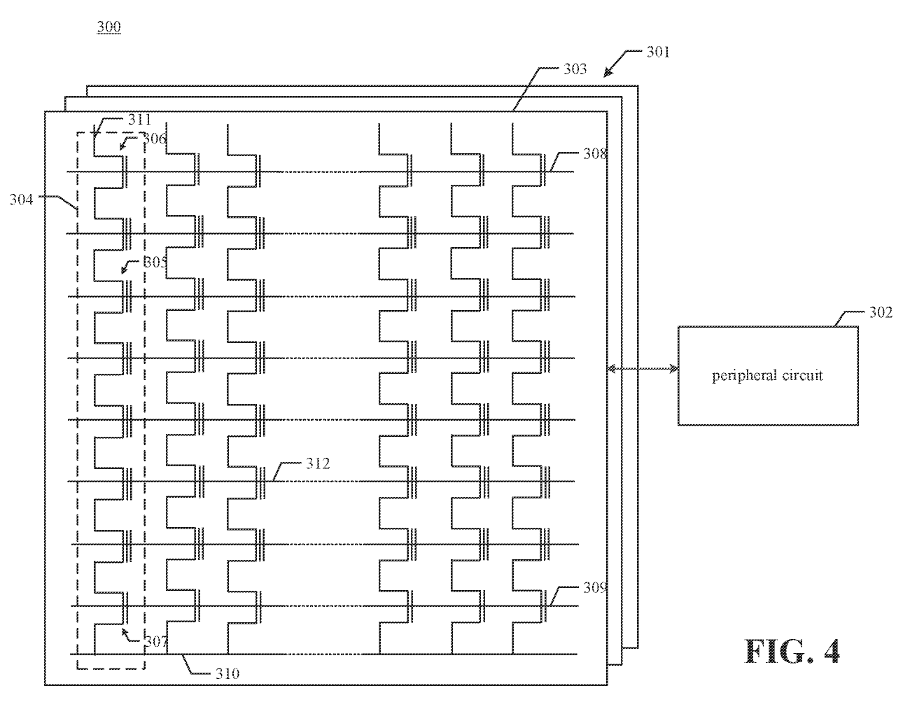

FIG. 4 is a schematic circuit diagram of an example memory device 300 including a peripheral circuit according to an example of the present disclosure. The memory device 300 may be an example of the memory device 103 in FIG. 1.The memory device 300 may include a memory array 301 and a peripheral circuit 302 coupled to the memory array 301.Taking the memory array 301 as a three-dimensional NAND type memory array as an example for description, the memory cells 305 are NAND memory cells, and are provided in the form of an array of memory strings 304, wherein each memory string 304 extends vertically above a substrate (not shown). In some examples, each memory string 304 includes a plurality of memory cells 305 coupled in series and stacked vertically. Each memory cell 305 may hold a continuous analog value, e.g., a voltage or charge, depending on the number of electrons trapped within an area of the memory cell 305.Each memory cell 305 may comprise a floating gate type memory cell including a floating gate transistor, or a charge trapping type memory cell including a charge trapping transistor.

In some examples, each memory cell 305 is a Single Level Cell (SLC) having two possible memory states and thus may store one bit of data. For example, the first memory state “0” may correspond to a first threshold voltage distribution, and the second memory state “1” may correspond to a second threshold voltage distribution. In some examples, each memory cell 305 is a multi-level cell (MLC) capable of storing more than a single bit of data in four or more memory states, e.g., a multi-level cell (MLC) storing two bits per cell, a triple level cell (TLC) storing three bits per cell, or a Quad-Level Cell (QLC) storing four bits per cell.

As shown in FIG. 4, each memory string 304 may include a bottom select transistor (BST) 307 at its source end and a top select transistor (TST) 306 at its drain end. The bottom select transistor 307 and the top select transistor 306 may be configured to activate a selected memory string 304 during read and program operations. In some examples, the sources of the memory strings 304 in the same memory block 303 may be coupled through a common source line (CSL) 310. For example, all memory strings 304 in the same memory block 303 have an array common source (ACS). According to some examples, the top select transistor 306 of each memory string 304 is coupled to a respective bit line (BL) 311, from which data may be read or written via an output bus (not shown). In some examples, each memory string 304 is configured to be selected or deselected by at least one of applying a select voltage (e.g., a voltage higher than a threshold voltage of the top select transistor 306) or a deselect voltage (e.g., 0V) to a top select gate (TSG) of the respective top select transistor 306 through one or more top select lines (TSL) 308 or applying a select voltage (e.g., a voltage higher than a threshold voltage of the bottom select transistor 307) or a deselect voltage (e.g., 0V) to a bottom select gate (BSG) of the respective bottom select transistor 307 through one or more bottom select lines (BSL) 309.

As shown in FIG. 4, the memory string 304 may be organized into a plurality of memory blocks 303, each of which may have a common source line 310. In some examples, each memory block 303 is a basic data unit for an erase operation, e.g., all memory cells 305 on the same memory block 303 are erased simultaneously. To erase the memory cells 305 in the selected memory block, a common source line 310 coupled to the selected memory block and unselected memory blocks in the same plane as the selected memory block may be biased with an erase voltage. It should be understood that in some examples, the erase operation may be performed at a half memory block level, at a quarter memory block level, or at a level having any suitable number of memory blocks or any suitable fractions of a memory block. Memory cells 305 of adjacent memory strings 304 may be coupled through word lines 312 that select which row of memory cells 305 is affected by read or program operations.

In some examples, the peripheral circuit 302 may include any suitable analog, digital, and mixed-signal circuit to enable operations of the memory array 301 by applying and sensing at least one of voltage signals or current signals to and from each of the target memory cells 305 through the bit lines 311, the word lines 312, the common source lines 310, the bottom select lines 309, and the top select lines 308. The peripheral circuit 302 may include various types of peripheral circuit formed using metal-oxide-semiconductor technology.

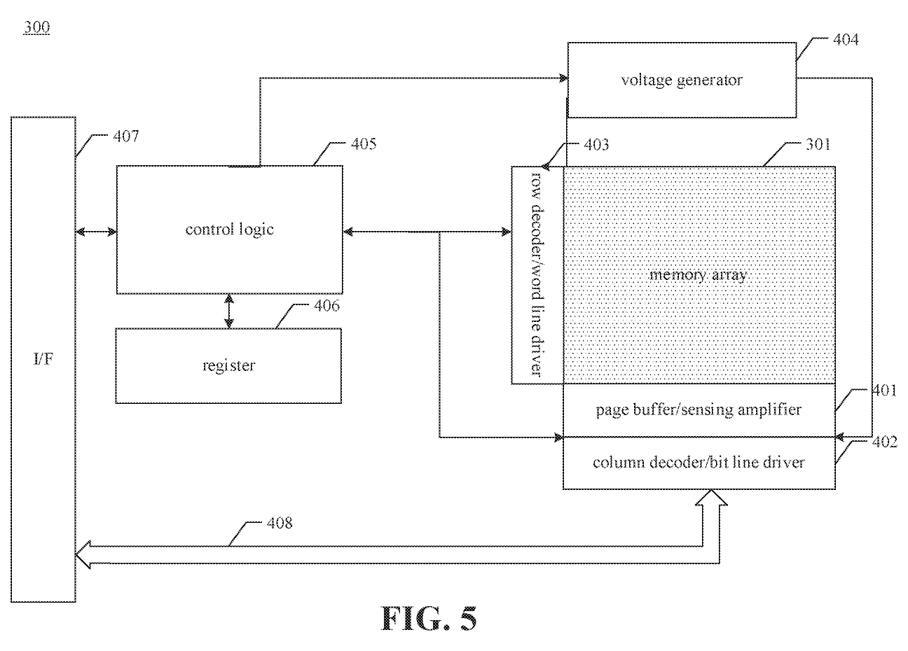

FIG. 5 shows some example peripheral circuits including a page buffer/sense amplifier 401, a column decoder/bit line driver 402, a row decoder/word line driver 403, a voltage generator 404, control logic 405, registers 406, a flash interface 407, and a data bus 408. It should be understood that in some examples, additional peripheral circuits not shown in FIG. 5 may also be included.

The page buffer/sense amplifier 401 may be configured to read data from and program (write) data into the memory array 301 according to control signals from the control logic 405. In one example, the page buffer/sense amplifier 401 may store a page of programming data (write data) to be programmed into the memory array 301.In another example, the page buffer/sense amplifier 401 may perform a program verify operation to ensure that data has been properly programmed into memory cells coupled to the selected word line. In yet another example, the page buffer/sense amplifier 401 may also sense a low power signal from the bit line representing a data bit stored in the memory cell, and amplify the small voltage swing to an identifiable logic level in a read operation. The column decoder/bit line driver 402 may be configured to be controlled by the control logic 405 and select one or more memory strings by applying bit line voltages generated from the voltage generator 404.

The row decoder/word line driver 403 may be configured to be controlled by the control logic 405 and select/deselect a memory block of the memory array 301 and select/deselect a word line of the memory block. The row decoder/word line driver 403 may also be configured to drive a word line using a word line voltage generated from the voltage generator 404. In some examples, the row decoder/word line driver 403 may also select/deselect and drive the bottom select line and the top select line. As described in detail below, the row decoder/word line driver 403 is configured to perform a program operation on memory cells coupled to the selected word line(s). The voltage generator 404 may be configured to be controlled by the control logic 405 and generate word line voltages (e.g., read voltages, program voltages, pass voltages, local voltages, verify voltages, etc.), bit line voltages, and source line voltages to be supplied to the memory array 301.

The control logic 405 may be coupled to each peripheral circuit described above and configured to control operations of each peripheral circuit. The registers 406 may be coupled to the control logic 405 and include status registers, command registers, and address registers for storing status information, command operation codes (OP codes), and command addresses for controlling operations of each peripheral circuit. The flash interface 407 may be coupled to the control logic 405 and act as a control buffer to buffer control commands received from a host (not shown) and relay it to the control logic 405 and buffer status information received from the control logic 405 and relay it to the memory controller. The flash interface 407 may also be coupled to the column decoder/bit line driver 402 via the data bus 408 and act as a data I/O interface and a data buffer to buffer data and send it to the memory array 301 or receive and buffer data from the memory array 301.

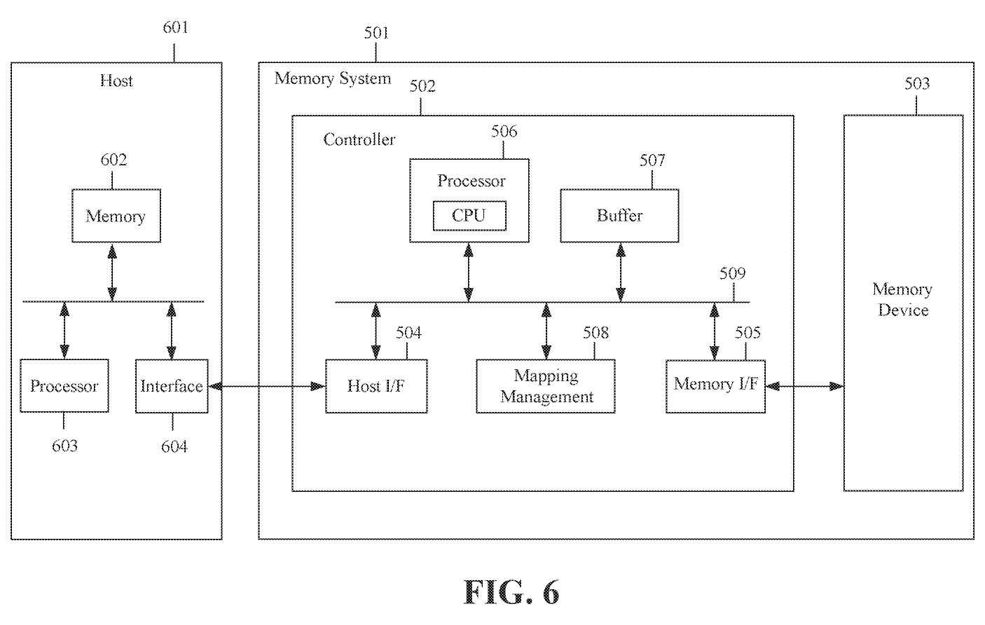

In some examples, FIG. 6 is a schematic composition diagram 1 of a system according to an example of the present disclosure. As shown in FIG. 6, the system comprises a host 601 and a memory system 501 comprising a memory device 503 and a controller 502, wherein the controller is coupled to the host 601 through a host interface 504 and is coupled to the memory device 503 through a memory interface 505. The controller 502 may include a flash translation layer (FTL), and in some examples, the controller 502 may include a first processor 506 and a mapping management module 508 coupled to the first processor 506 through a bus 509 to implement a mapping management function.

In some examples, the host 601 supports an operating system (OS) and includes a file system and an underlying driver. A user may issue a request at an application layer of the operating system, the file system may convert the operation request to a command conforming to a corresponding protocol via the underlying driver, and the memory system 501 receives the command through the host interface 504 and performs a corresponding operation. For example, when the user initiates a file storage operation at the application layer, the host 601 may send a write command to the memory system 501, the controller 502 may receive the write command and receive write data corresponding to the file and a logical address for the write data in response to the write command, and temporarily store the write data in a buffer 507 of the controller 502. The mapping management module 508 may allocate a physical address to the write data, establish a mapping relationship of logical address to physical address (L2P) for the write data, and store mapping information corresponding to the mapping relationship. The controller 502 may send a programming command to the memory device 503 via the memory interface 505, the memory device 503 may receive the programming command and receive the write data and the physical address for the write data in response to the programming command, and store the write data to a location in the memory array corresponding to the physical address for the write data. In order to improve the user experience, in the process of file storage, after the data is stored in the buffer 507 of the controller 502, the completion of the file storage operation will be feedback, so as to avoid too long waiting time. Similarly, in the process of file deletion, after target data is converted into invalid data in the manner of unmapping the mapping information of the target data, the completion of the file delete operation will be feedback, and the target data stored in the memory device 503 is not erased at once, which may result in the possibility of recovering the data corresponding to the file from the memory device 503 by technical means even after the file delete operation is completed, which may cause serious data security risks.

In view of the above problems, the present disclosure provides the following examples.

The disclosure provides a system, comprising: a host configured to: send a command comprising address information and a flag bit of target data, wherein the flag bit is to indicate whether to delete the target data; and a memory system coupled with the host and comprising: a memory device; and a controller coupled with the memory device and configured to: receive the command; and perform a delete operation on the target data based on the flag bit being in a state indicating to delete the target data.

In some examples, referring to FIG. 6, a system includes: a memory system 501 including a memory device 503 and a controller 502 coupled with the memory device 503; and a host 601 coupled with the memory system 501. Here, the memory device 503 may comprise the memory device 300 in the above example. The host 601 includes a memory 602 and a second processor 603 coupled to the memory 602, and the host 601 is coupled to the host interface 504 in the controller 502 through the interface 604. Here, the second processor 603 is an example of a processor in a host in the system provided by the present disclosure.

In some examples, the host 601 is configured to: send a command comprising address information and a flag bit of target data, wherein the flag bit is to indicate whether to delete the target data.

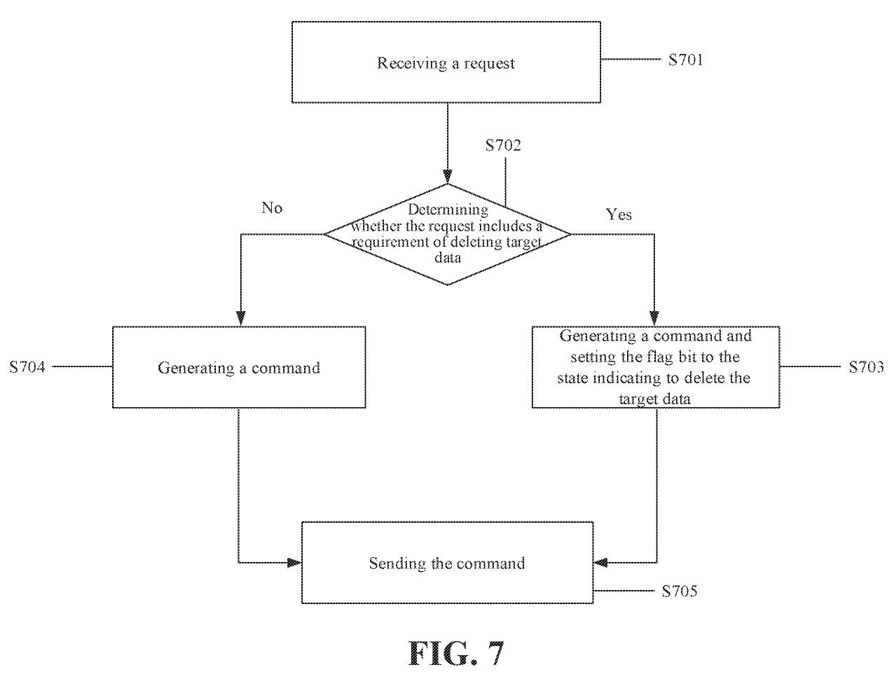

In some examples, the second processor 603 may be configured to perform the operations shown in FIG. 7. In some examples, the second processor 603 may be configured to: perform operation S701, receiving a request; perform operation S702, determining whether the request includes a requirement of deleting target data; if yes, then perform operation S703, generating a command comprising address information and a flag bit of the target data, and setting the flag bit to the state indicating to delete the target data; if no, then perform operation S704, generating a command comprising the address information of the target data; and finally perform operation S705, sending the command. Here, sending the command may include sending the command to the memory system 501 through the interface 604.

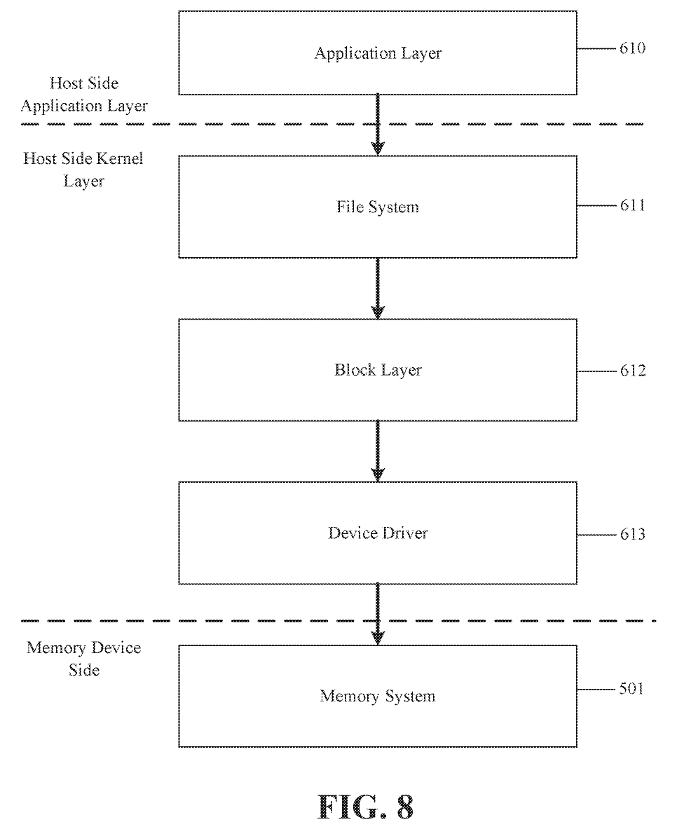

In some examples, take the host 601 comprising a file system as an example, FIG. 8 is a schematic composition diagram 2 of a system according to an example of the present disclosure. With reference to FIG. 6 and FIG. 8, the host 601 may include an application layer 610 and a kernel layer, wherein the kernel layer may further include a file system layer 611, a block device layer 612, and a device driver layer 613. The memory 602 may be configured to store software of each layer, and when the second processor 603 runs the software stored in the memory 602, functions of each layer may be implemented.

In some examples, with reference to FIG. 7 and FIG. 8, the request may comprise a file delete request initiated by the user through the application layer 610, the target data may comprise data stored in the memory system 501 corresponding to a target file specified in the file delete request. In some examples, the target data is stored in the memory device 503 of the memory system 501. The address information of the target data may include a plurality of logical address ranges, and the file system layer 611 may generate corresponding block input output (Bio) information according to the call of the application layer 610, wherein each Bio may include a logical address range, and when the file delete request includes the requirement of deleting the target data, the Bio may carry delete prompt information. The file system layer 611 may send the plurality of Bio to the block device layer 612, and the block device layer 612 may in turn combine the plurality of Bio into request information, and send the request to the device driver layer 613. The device driver layer 613 may generate an Unmap Command or a Dataset Management Command according to the request, use one bit in a reserved region of the unmap command or the dataset management command as a flag bit according to the delete prompt information carried in the request, and set the flag bit to a state indicating to delete the target data. Here, the reserved region in the command includes at least one bit that has not been configured for any function, wherein the bit may be “0” by default, and setting the flag bit to the state indicating to delete the target data may include setting the flag bit of the target data to “1”.

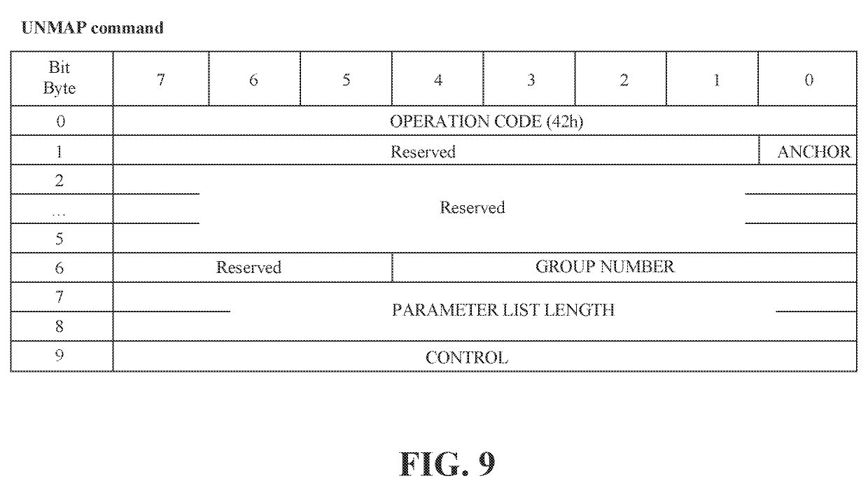

In an example, the interface 604 of the host 601 and the host interface 504 of the controller 502 are linked according to the specification of the SCSI protocol, and the command including the address information and the flag bit of the target data comprises an unmap command. FIG. 9 shows a format of the unmap command, wherein the flag bit of the target data may comprise one bit in Byte 2 to Byte 5 in the unmap command, or one bit in other reserved regions.

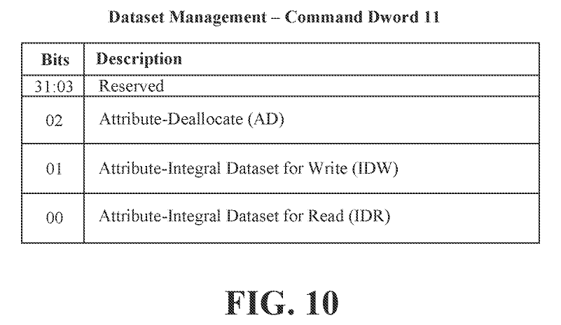

In an example, the interface 604 of the host 601 and the host interface 504 of the controller 502 are linked according to the specification of the NVMe protocol, and the command including the address information and the flag bit of the target data comprises a dataset management command. FIG. 10 shows a format of a Command Dword 11 of the dataset management command, wherein the flag bit of the target data may comprise one bit in Bits 31: 03 in the Command Dword 11 of the dataset management command, or one bit in other reserved regions. In addition, in the dataset management command, Bit 02 in the Command Dword 11 is set to 1 to indicate to unmap the mapping information from the logical address of the target data to the physical address.

In some other examples, when the host 601 communicates with the controller 502 through other protocols, the command including the address information and the flag bit of the target data may further comprise a command conforming to the other protocol standards.

In the examples of the present disclosure, in the case that the user has a requirement for completely deleting sensitive data or privacy data, the host may, when generating the command indicating to unmap the mapping information of the target data, utilize the reserved region in the command by using one bit in the reserved region as the flag bit of the target data and setting the flag bit to the state indicating to delete the target data, and send the command including the address information and the flag bit of the target data to the controller 502.

In some examples, the controller 502 is configured to: receive the command; and perform a delete operation on the target data based on the flag bit being in a state indicating to delete the target data.

In some examples, the controller 502 is further configured to: unmap mapping information of logical address to physical address of the target data in response to the command.

In some examples, the mapping management module 508 in the controller 502 is configured to maintain a mapping table that includes the mapping information of logical address to physical address of data stored in the memory device 503. The mapping management module 508 in the controller 502 may be configured to: in response to the unmap command or the dataset management command, search for mapping information of the logical address to the physical address of the target data in the mapping table based on the logical address of the target data carried in the command, and unmap the mapping information of the logical address to the physical address of the target data. In some examples, the logical address in a mapping entry corresponding to the mapping information of the logical address to the physical address of the target data in the mapping table may be deleted, and only the physical address of the target data is kept. Alternatively, the mapping entry can be marked as invalid. After the mapping information of the logical address to the physical address of the target data is unmapped, the target data will no longer be obtained from the memory system 501 based on the original logical address, for example, the target data in the memory device 503 will become invalid data. If the flag bit is not in the state indicating to delete the target data, the target data in the memory device 503 will not be deleted immediately, but will continue to be stored in the memory device 503. The controller 502 may be configured to delete the target data that has become invalid data through a garbage collection operation or other operations that can be run in the background when in an idle state or when the data amount of invalid data in the memory device 503 reaches the threshold.

In some examples, when the flag bit is in a state indicating to delete the target data, performing the delete operation on the target data may comprise erasing the target data from the memory device 503, for example, the controller 502 may be configured to send an erase command to the memory device 503 to erase the target data in the memory device 503. Thus, the target data will be completely deleted and cannot be retrieved from the memory device 503.

In some examples, the memory device 503 includes a plurality of memory blocks, and in one delete operation, the target data may include a plurality of portions, which are respectively stored in different memory blocks, and the memory blocks storing the target data may further store other valid data. As such, prior to performing the delete operation, the controller 502 is further configured to: transfer valid data in the same memory block as the target data to another memory block.

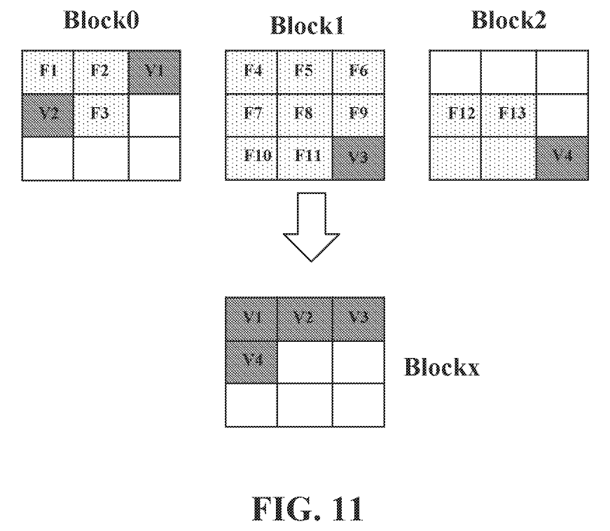

In an example, FIG. 11 is a schematic diagram of a data transfer operation according to an example of the present disclosure. As shown in FIG. 11, the target data may comprise a plurality of portions respectively stored in a plurality of memory blocks, for example, the target data may comprise a plurality of portions respectively stored in three memory blocks Block0, Block1, and Block2. After unmapping the mapping information of the logical address to the physical address of the target data, the target data is converted into invalid data F1 to F13. As such, before performing the delete operation on the target data, it is necessary to transfer the valid data V1 to V4 that are located in the same memory block as the target data to another memory block Blockx, and then the three memory blocks Block0 to Block2 can be erased in units of memory blocks. Here, the memory block Blockx may be an idle memory block or a memory block storing other valid data before receiving the valid data V1 to V4; the valid data transfer process may include performing a read operation on an area in which valid data is stored in the memory blocks Block0 to Block2, and then writing the read data into the memory block Blockx.

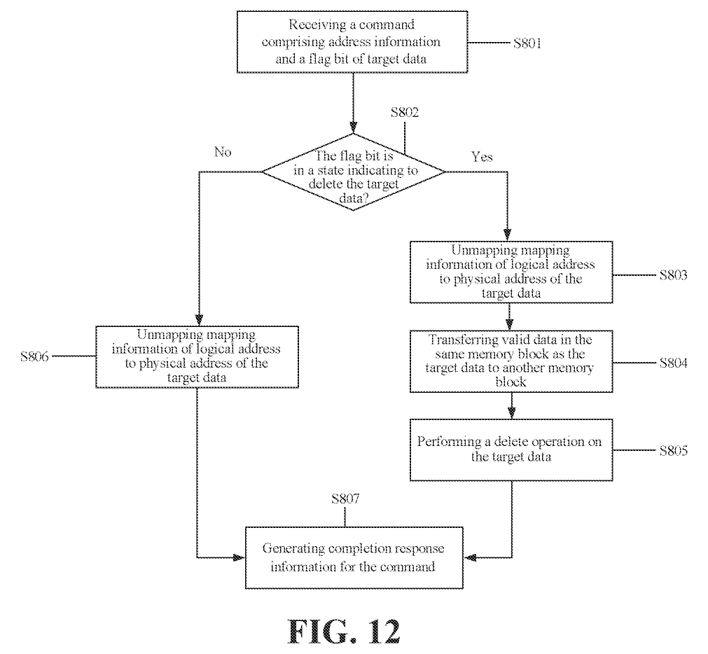

In an example, the controller 502 may be configured to perform the operations shown in FIG. 12, and in some examples, the controller 502 may be configured to: perform operation S801, receiving a command comprising address information and a flag bit of target data; perform operation S802, determining whether the flag bit is in a state indicating to delete the target data. If yes, then perform operation S803, unmapping mapping information of logical address to physical address of the target data; perform operation S804, transferring valid data in the same memory block as the target data to another memory block; perform operation S805, performing a delete operation on the target data; and perform operation S807, generating completion response information for the command. And if no, then perform operation S806, unmapping mapping information of logical address to physical address of the target data; and perform operation S807, generating completion response information for the command. For example, when the flag bit is in the state of indicating to delete the target data, the completion response information for the command is fed back to the host only after the target data is deleted, to ensure that the target data has been completely deleted.

In an example, the flash translation layer of the controller 502 may include a delete module configured to: when receiving the command comprising the address information and the flag bit of the target data, determine the state of the flag bit; when the flag bit is in the state indicating to delete the target data, initiate a data transfer operation and a delete operation; and send a corresponding command to the memory device 503 through the memory interface 505, to transfer valid data in the same memory block as the target data to another memory block, and delete the target data in the memory device 503.

In this example of the present disclosure, when the file delete request initiated by the application layer includes a requirement of deleting the target data, the host may generate a command including a flag bit that is in a state indicating to delete the target data and send the command to the memory system. The controller may perform a delete operation on the target data in response to the command, and the controller may feedback completion response information for the command to the host after the delete operation performed on the target data stored in the memory device is completed. Thereby, immediate deletion of the target data may be implemented, and a case in which the target data may be obtained from the memory device by technical means subsequently may be avoided, to protect the sensitive data or the privacy data.

It should be noted that the system in the foregoing example is mainly used as an example in which the host terminal comprises a host device including a file system, but the present disclosure is not limited thereto. In some other examples, the command comprising the address information and the flag bit of the target data may be directly sent to the memory system without using the file system. For example, a Storage Performance Development Kit (SPDK) application or another application capable of generating the NVMe command may directly generate the command comprising the address information and the flag bit of the target data, to implement complete deletion of the target data.

The present disclosure further provides a memory system. Referring to FIG. 6, the memory system comprises: a memory device 503; and a controller 502 coupled to the memory device 503 and configured to: receive a command comprising address information and a flag bit of target data, wherein the flag bit is to indicate whether to delete the target data; perform a delete operation on the target data based on the flag bit being in a state indicating to delete the target data.

In some examples, the target data is stored in the memory device 503.

In some examples, the controller 502 is further configured to: unmap mapping information of logical address to physical address of the target data in response to the command.

In some examples, the memory device 503 comprises a plurality of memory blocks, and prior to performing the delete operation, the controller 502 is further configured to: transfer valid data in the same memory block as the target data to another memory block.

In some examples, after the delete operation is completed, the controller 502 is further configured to: generate completion response information for the command.

In some examples, the command comprising address information and a flag bit of target data may comprise an unmap command or a dataset management command.

In the example of the present disclosure, the controller may unmap the mapping information of the target data in response to the unmap command or the dataset management command, perform the delete operation on the target data stored in the memory device based on the flag bit in the command being in a state indicating to delete the target data, and generate the completion response information for the command only after the delete operation is completed. As such, the complete deletion of the target data may be achieved, and a case in which the target data may be recovered from the memory device by technical means after performing the unmapping operation may be avoided, thereby protecting the sensitive data or the privacy data, and improving the data security of the memory system.

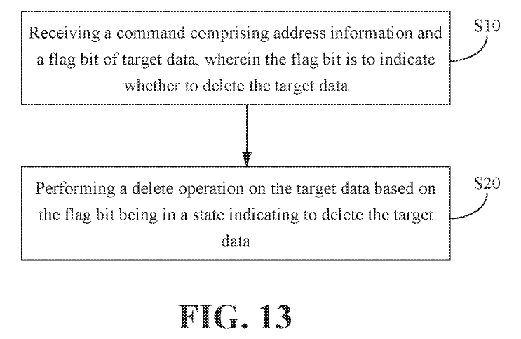

The present disclosure further provides an operation method of a memory system. FIG. 13 is a schematic flowchart of an operation method of a memory system according to an example of the present disclosure. As shown in FIG. 13, the operation method of the memory system comprises following operations:

Operation S10: receiving a command comprising address information and a flag bit of target data, wherein the flag bit is to indicate whether to delete the target data;

Operation S20: performing a delete operation on the target data based on the flag bit being in a state indicating to delete the target data.

In some examples, the operation method further includes: unmapping mapping information of logical address to physical address of the target data in response to the command.

In some examples, prior to performing the delete operation, the operation method further comprises: transferring valid data in the same memory block as the target data to another memory block.

In some examples, after the deleting operation is completed, the operation method further comprises: generating completion response information for the command.

The features disclosed in the several device examples provided by the present disclosure may be arbitrarily combined without conflict to obtain a new device example.

The method disclosed in the several method examples provided by the present disclosure may be arbitrarily combined without conflict to obtain a new method example.

The above descriptions are only examples of the present disclosure, but the protection scope of the present disclosure is not limited thereto, and variations or replacements may be conceived by any person skilled in the art easily within the technical scope of the present disclosure, which should be covered within the protection scope of the present disclosure.

What is claimed is:

1. A memory system, comprising:
a memory device; and
a controller coupled to the memory device and configured to:
receive a command comprising address information and a flag bit of target data, wherein the flag bit is to indicate whether to delete the target data; and
perform a delete operation on the target data based on the flag bit being in a state indicating to delete the target data.

2. The memory system of claim 1, wherein the target data is stored in the memory device.

3. The memory system of claim 2, wherein the controller is further configured to:
unmap mapping information of logical address to physical address of the target data in response to the command.

4. The memory system of claim 3, wherein the memory device comprises a plurality of memory blocks, and prior to performing the delete operation, the controller is further configured to:
transfer valid data in the same memory block as the target data to another memory block.

5. The memory system of claim 2, wherein after the delete operation is completed, the controller is further configured to:
generate completion response information for the command.

6. The memory system of claim 1, wherein the command comprises an unmap command or a dataset management command.

7. A system, comprising:
a host configured to:
send a command comprising address information and a flag bit of target data, wherein the flag bit is to indicate whether to delete the target data; and
a memory system coupled with the host and comprising:
a memory device; and
a controller coupled with the memory device and configured to:
receive the command; and
perform a delete operation on the target data based on the flag bit being in a state indicating to delete the target data.

8. The system of claim 7, wherein the host comprises:
a memory; and
a processor coupled to the memory and configured to:
receive a request; and
set the flag bit to the state indicating to delete the target data based on the request comprising a requirement of deleting the target data.

9. The system of claim 7, wherein the target data is stored in the memory device.

10. The system of claim 9, wherein the controller is further configured to:
unmap mapping information of logical address to physical address of the target data in response to the command.

11. The system of claim 10, wherein the memory device comprises a plurality of memory blocks, and prior to performing the delete operation, the controller is further configured to:
transfer valid data in the same memory block as the target data to another memory block.

12. The system of claim 9, wherein after the delete operation is completed, the controller is further configured to:
generate completion response information for the command; and
send the completion response information to the host.

13. The system of claim 7, wherein the command comprises an unmap command or a dataset management command.

14. An operation method of a memory system, comprising:
receiving a command comprising address information and a flag bit of target data, wherein the flag bit is to indicate whether to delete the target data; and
performing a delete operation on the target data based on the flag bit being in a state indicating to delete the target data.

15. The operation method of the memory system of claim 14, wherein the target data is stored in a memory device.

16. The operation method of the memory system of claim 15, further comprising:
unmapping mapping information of logical address to physical address of the target data in response to the command.

17. The operation method of the memory system of claim 16, wherein prior to performing the delete operation, the operation method further comprises:
transferring valid data in the same memory block as the target data to another memory block.

18. The operation method of the memory system of claim 15, wherein after the deleting operation is completed, the operation method further comprises:
generating completion response information for the command.

19. The operation method of the memory system of claim 18, wherein after generating the completion response information for the command, the operation method further comprises:
sending the completion response information to the host.

20. The operation method of the memory system of claim 15, wherein the command comprises an unmap command or a dataset management command.
